(19) United States
(12) Patent Application Publication
(10) Pub. No.: US 2009/0291338 A1
(43) Pub. Date: Nov. 26, 2009

(54) Increasing The Efficiency Of A Fuel Cell

(76) Inventors: James F. McElroy, Suffield, CT (US); Michael D. Gasda, Albany, NY (US)

Correspondence Address: TROP, PRUNER & HU, P.C., 1616 S. VOSS ROAD, SUITE 750, HOUSTON, TX, 77057-2631, US

(21) Appl. No.: 12/433,423

(22) Filed: Apr. 30, 2009

Related U.S. Application Data
(60) Provisional application No. 61/126,140, filed on May 1, 2008.

(51) Int. Cl. H01M 8/04; H01M 8/18

(52) U.S. Cl. 429/17; 429/19

(57) ABSTRACT

A technique includes removing nitrogen from an air stream to produce an enriched oxygen stream and communicating the enriched oxygen stream to a cathode chamber of a fuel cell. The technique includes transferring the nitrogen that is removed from the air stream to a reactant stream of the fuel cell system.

This application claims the benefit under 35 U.S.C. § 119(e) to U.S. Provisional Patent Application Ser. No. 61/126,140, entitled, “INCREASING THE EFFICIENCY OF A FUEL CELL,” which was filed on May 1, 2008, and is hereby incorporated by reference in its entirety.

### BACKGROUND

The invention generally relates to increasing the efficiency of a fuel cell and more particularly relates to using partial pressure swing adsorption to enrich an air reactant stream to a fuel cell with oxygen.

A fuel cell is an electrochemical device that converts chemical energy directly into electrical energy. For example, one type of fuel cell includes a proton exchange membrane (PEM) that permits only protons to pass between an anode and a cathode of the fuel cell. Typically PEM fuel cells employ sulfonic-acid-based ionomers, such as Nafion, and operate in the 50° Celsius (C) to 75° C. temperature range. Another type employs a phosphoric-acid-based polybenziamidazole, PBI, membrane that operates in the 150° to 200° temperature range. At the anode, diatomic hydrogen (a fuel) is reacted to produce protons that pass through the PEM. The electrons produced by this reaction travel through circuitry that is external to the fuel cell to form an electrical current. At the cathode, oxygen is reduced and reacts with the protons to form water. The anodic and cathodic reactions are described by the following equations:

Anode: H₂→2H⁺+2e⁻ Equation 1

Cathode: O₂+4H⁺+4e⁻→2H₂O Equation 2

The PEM fuel cell is only one type of fuel cell. Other types of fuel cells include direct methanol, alkaline, phosphoric acid, molten carbonate and solid oxide fuel cells.

A typical fuel cell has a terminal voltage near one volt DC. For purposes of producing much larger voltages, several fuel cells may be assembled together to form an arrangement called a fuel cell stack, an arrangement in which the fuel cells are electrically coupled together in series to form a larger DC voltage (a voltage near 100 volts DC, for example) and to provide more power.

The fuel cell stack may include flow plates (graphite composite or metal plates, as examples) that are stacked one on top of the other, and each plate may be associated with more than one cell of the stack. The plates may include various surface flow channels and orifices to, as examples, route the reactants and products through the fuel cell stack. Electrically conductive gas diffusion layers (GDLs) may be located on each side of a catalyzed PEM to form the anode and cathodes of each fuel cell. In this manner, reactant gases from both the anode and cathode flow-fields may diffuse through the GDLs to reach the catalyst layers.

### SUMMARY

In an embodiment of the invention, a technique includes removing nitrogen from an air stream to produce an enriched oxygen stream and communicating the enriched oxygen stream to a cathode chamber of a fuel cell. The technique includes transferring the nitrogen that is removed from the air stream to a reactant stream of the fuel cell system.

In another embodiment of the invention, a technique includes communicating an air stream through a partial pressure adsorption bed to produce an enriched oxygen stream and communicating the enriched oxygen stream to a cathode chamber of a fuel cell. The technique includes communicating a reactant stream of the fuel cell through the adsorption bed to regenerate the bed.

In yet another embodiment of the invention, a fuel cell system includes a fuel cell, a partial pressure adsorption bed and a control subsystem. The control subsystem is adapted to communicate an air stream through the partial pressure adsorption bed to produce an enriched oxygen stream and communicate the enriched oxygen stream to a cathode chamber of the fuel cell. The control subsystem is also adapted to communicate a reactant stream of the fuel cell system through the adsorption bed to regenerate the bed.

Advantages and other features of the invention will become apparent from the following drawing, description and claims.

### BRIEF DESCRIPTION OF THE DRAWING

FIGS. 1, 2 and 3 are flow diagrams of techniques to increase the partial pressure of oxygen that is provided to a fuel cell according to embodiments of the invention.

FIG. 4 is a schematic diagram of a pure hydrogen-based fuel cell system according to an embodiment of the invention.

FIGS. 5 and 7 are flow diagrams depicting techniques to enhance the partial pressure of oxygen that is provided to a fuel cell that reacts a reformate that is produced from natural gas according to embodiments of the invention.

FIGS. 6, 8, 9 and 10 are schematic diagrams of natural gas-based fuel cell systems according to embodiments of the invention.

### DETAILED DESCRIPTION

Operating a proton exchange membrane (PEM) fuel cell using reactants at near ambient pressure has many advantages, which include the elimination of the need for complex pressure controls, reduced system component costs and enhanced system reliability. However, by operating the fuel cell with reactants at ambient pressure, there may be a significant loss in cell efficiency at a given cell current density. For example, a low temperature PEM fuel cell, which operates at ambient pressure at 70° C. has a voltage level under operational load about 0.10 volts lower than a low temperature PEM fuel cell that operates at 70° C. at 3.5 atmospheres of reactant pressure.

Assuming that in the above-example the low temperature PEM fuel cell operates with pure hydrogen on the fuel anode and air on the oxidant cathode, a majority of the voltage improvement comes from increased cathode activity. According to the Nernst voltage correction for variations in pressure, a three times increase in hydrogen partial pressure accounts for a 0.016 volt improvement, and the increased oxygen partial pressure accounts for only a 0.008 volt improvement. The sum of these voltage corrections is far less than the observed 0.10 volt increase. Thus, the oxygen cathode responds many times greater than the Nernst voltage correction would predict. Conversely, it has been observed in PEM water electrolyzers that the oxygen anode responds many times less than the Nernst equation predicts. From these observations, it is hypothesized that the effective oxygen partial pressure at the three phase cathode interface of a PEM hydrogen/oxygen fuel cell is much lower than the oxygen partial pressure in the oxygen flow fuel chamber; and the effective oxygen partial pressure at the oxygen anode three-phase interface of a PEM water electrolyzer is much higher than the oxygen partial pressure in the oxygen flow fuel chamber. On the other hand, there is agreement between the Nernst voltage correction for pressure and the observed voltage change with the pressure for hydrogen oxidation and reduction electrodes.

Therefore, in accordance with embodiments described herein, the partial pressure of the oxygen to the fuel cell is increased for purposes of maximizing the efficiency of the cell. The oxygen that is received by the fuel cell is communicated by way of an air reactant stream. One way to increase the partial pressure of the oxygen in the air reactant stream (and thus, enrich the oxygen that is provided to the fuel cell) is to remove nitrogen from the stream.

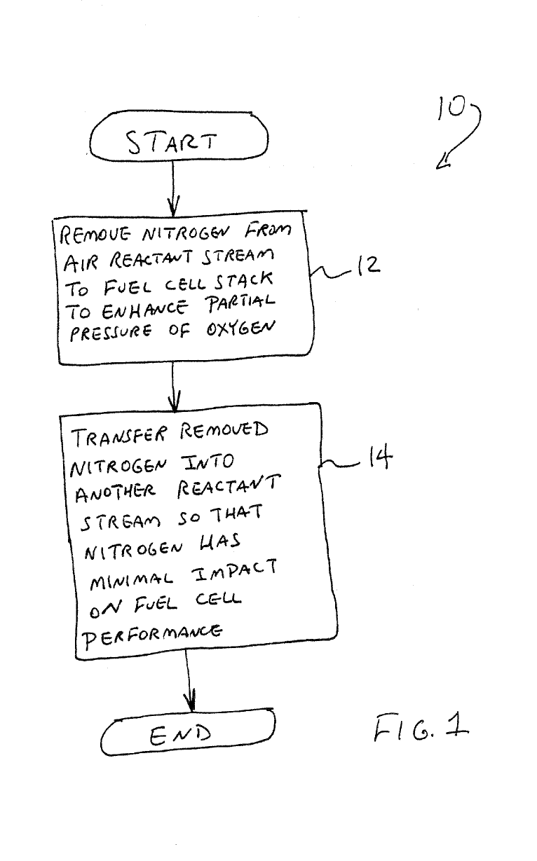

More specifically, FIG. 1 depicts a technique 10 that may be generally used with a fuel cell system in accordance with embodiments of the invention. Pursuant to the technique 10, nitrogen is removed from the air reactant stream to a fuel cell stack to enhance the partial pressure of oxygen, as depicted in block 12. The removed nitrogen is transferred (block 14) into another reactant stream of the fuel cell system, where the nitrogen has a minimal impact on fuel cell performance.

One way to remove nitrogen from the air reactant stream is through the use of a partial pressure swing adsorption (PPSA) bed, sometimes called a concentration swing adsorption bed, which contains a molecular sieve. With this arrangement, the air reactant stream flows through the PPSA bed, which adsorbs at least one gas species from the mixture. In accordance with some embodiments of the invention, the PPSA bed adsorbs nitrogen from the incoming air reactant stream, which increases the partial pressure of oxygen in the outgoing stream from the PPSA bed. The bed must eventually be regenerated, a process in which the bed releases the captured gas species (such as nitrogen) into a purge flow through the bed. The purge flow is formed from a second independent gas that contains neither the adsorbed gas species nor the purified gas species, which causes the adsorbed species to be significantly desorbed into the second independent gas stream. A significant advantage of the use of the PPSA bed, as compared to other oxygen enrichment techniques, is that no compression or vacuum energy is required.

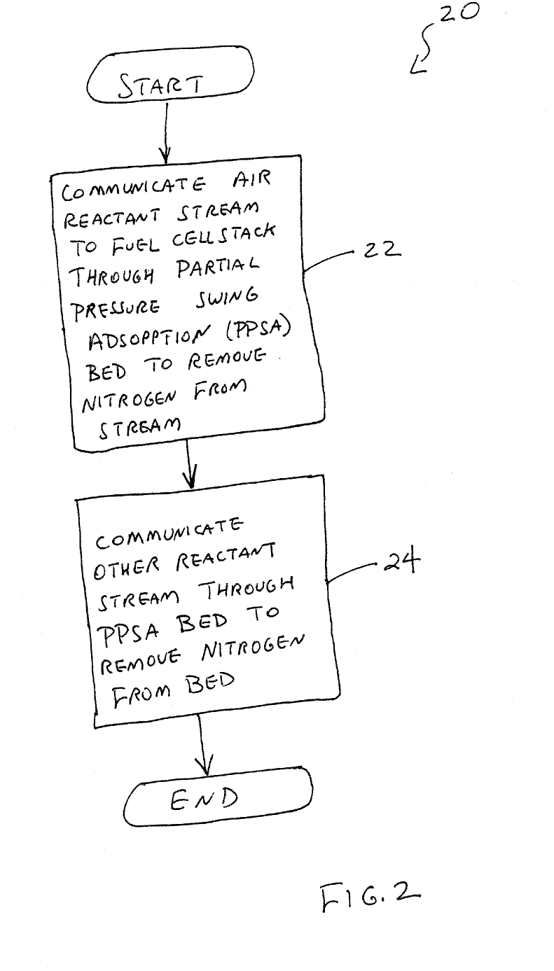

Referring to FIG. 2, in accordance with some embodiments of the invention, a technique 20 may be used for purposes of increasing the partial pressure of oxygen that is provided by a fuel cell. Pursuant to the technique 20, an air reactant stream to the fuel cell stack is first communicated through a PPSA bed to remove a gas species, such as nitrogen, from the stream, as depicted in block 22. Another reactant stream is communicated (block 24) through the PPSA bed to remove nitrogen from the bed for purposes of regenerating the bed.

As a more specific example, in accordance with embodiments of the invention, the air reactant stream is routed through an ambient pressure PPSA bed that contains a molecular sieve for adsorbing nitrogen. The resultant output stream contains a mixture of approximately 96% oxygen and 4% argon gases, which are delivered to the PEM fuel cell to raise the individual cell voltages by approximately 0.100 volts.

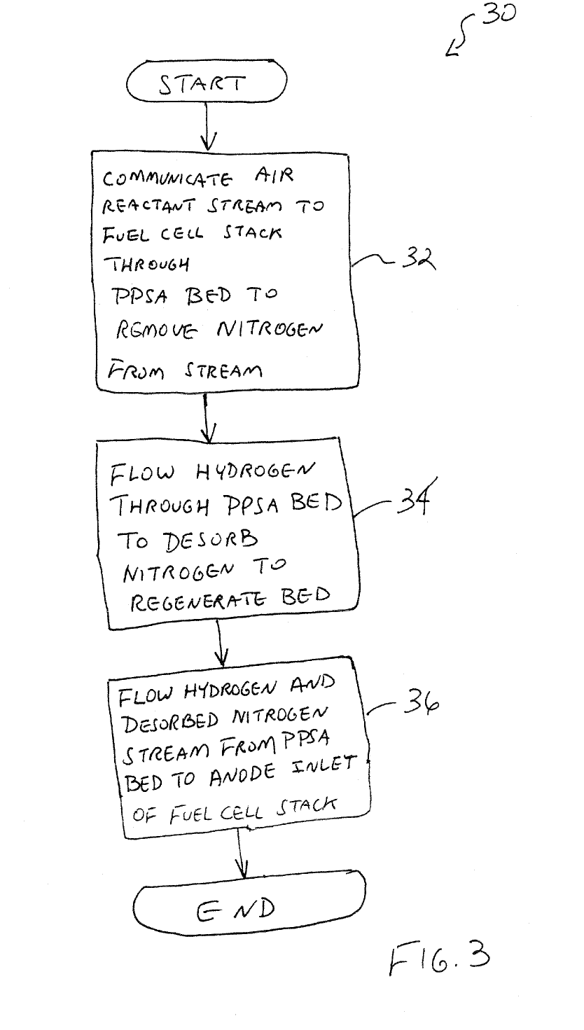

A substantially pure hydrogen flow may be used as a purge flow to regenerate the PPSA bed. More specifically, referring to FIG. 3, in accordance with some embodiments of the invention, a technique 30 includes communicating an air reactant stream to a fuel cell stack through a PPSA bed to remove nitrogen from the stream, pursuant to block 32. When it is time to regenerate the bed, hydrogen is flowed through the PPSA bed to desorb hydrogen to regenerate the bed, pursuant to block 34. The combined hydrogen and desorbed nitrogen stream from the PPSA bed may be flowed to the anode inlet of the fuel cell stack, pursuant to block 36.

In the desorbing process, the hydrogen fuel may be diluted with nitrogen to approximately 40% hydrogen and 60% nitrogen. The impact of the diluted hydrogen on the PEM fuel cell is to lower the individual cell voltages by approximately 0.010 volts. The net gain in the PEM fuel cell voltage due to the increase in oxygen partial pressure is approximately 0.090 volts, which equates to a 10% to 15% increase in the PEM fuel cell efficiency, as compared to a system that does not use oxygen enrichment. As described further below, multiple PPSA beds may be used to obtain a continuous process, i.e., one PPSA bed may be regenerated while the other enriches the incoming air reactant stream to the stack with oxygen.

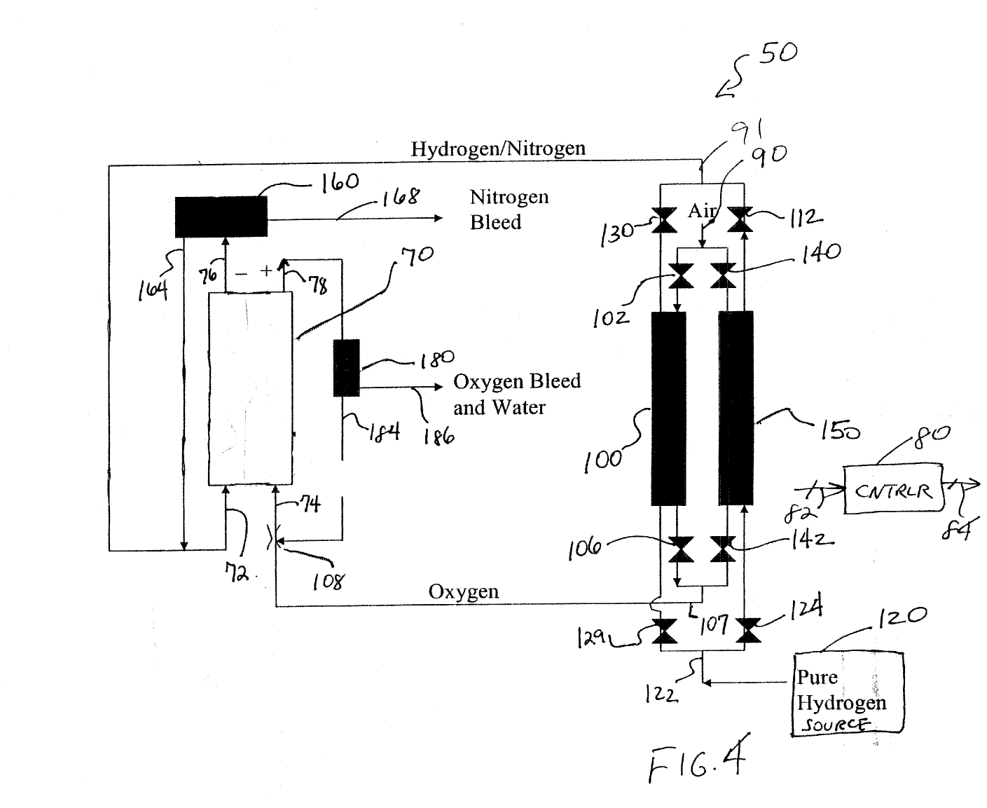

FIG. 4 depicts an exemplary embodiment of a hydrogen-based fuel cell system in accordance with some embodiments of the invention. As described further below, the fuel cell system 50 uses a PPSA bed to adsorb nitrogen and purges the bed with the pure hydrogen. For these embodiments of the invention, the molecular sieve material of the PPSA bed strongly adsorbs nitrogen and weakly adsorbs oxygen and hydrogen.

The fuel cell system 50 includes two PPSA adsorbent beds 100 and 150, which each have one of two states: a state in which the bed is adsorbing nitrogen to enhance the partial pressure of oxygen furnished to a fuel cell stack 70; and a state in which the bed is being regenerated, or desorbed, so that the bed releases its trapped nitrogen. The PPSA beds 100 and 150 alternate states to achieve a constant flow of oxidant to the fuel cell stack 70 so that one of the beds 100 and 150 is being regenerated to release its trapped nitrogen with hydrogen while the other bed 100, 150 is trapping nitrogen from the air reactant stream.

For purposes of the example below, it is assumed that the PPSA bed 100 is in the adsorption state to enrich the oxygen content of the air reactant stream that is provided to the fuel cell stack 70, and the bed 150 is in the regenerating state, although these roles reverse when it is time for the PPSA bed 100 to be regenerated.

The PPSA bed 100 receives an air reactant stream from an air reactant stream inlet 90. The air reactant stream 90 may be furnished by an air blower, for example, in accordance with some embodiments of the invention. The air flow from the air blower is communicated through the PPSA bed 100, where nitrogen is adsorbed into the stream. The resultant oxygen-enriched air reactant stream flows from the PPSA bed 100 to air reactant stream outlet 107 for the PPSA adsorbent beds 100 and 150 and then to a cathode inlet 74 of the fuel cell stack 70. The enriched oxygen stream flows through the cathode chamber of the fuel cell stack 70 and exits a cathode outlet 78 of the stack 70. In the context of this application, the “cathode chamber” refers to the cathode inlet and outlet plenum passageways as well as the cathode flow plate channels of the fuel cell stack 70.

In accordance with some embodiments of the invention, the cathode exhaust may be vented to ambient. However, in accordance with other embodiments of the invention, as depicted in FIG. 4, the cathode exhaust passes through a condenser 180 for purposes of removing water from the exhaust. The condenser 180 may include an oxygen bleed conduit 186 for purposes of bleeding some of the air flow and water from the condenser 180. An outlet 184 of the condenser 180 may be connected to a venturi inlet of a venturi 108. The main path of the venturi 108 is coupled between the outlet 107 and the cathode inlet 74, as depicted in FIG. 4. The venturi 108 creates a pressure drop to establish a cathode recirculation flow without requiring a dedicated recirculation blower, in accordance with some embodiments of the invention.

For purposes of regenerating the PPSA bed 150, a significantly pure (99 percent by volume, for example) hydrogen stream is furnished by a pure hydrogen source 120 is routed to a hydrogen inlet 122 for the PPSA adsorption beds 100 and 150 and flows from the inlet 122 through the bed 150. The relatively dry and pure hydrogen flow desorbs trapped nitrogen from the PPSA bed 150 to produce a combined hydrogen and nitrogen stream that exits a purge flow outlet 91 for the PPSA adsorption beds 100 and 150. From the outlet 91, the stream is communicated to an anode inlet 72 of the fuel cell stack 70. From the anode inlet 72, the combined hydrogen and nitrogen stream flows through the anode chamber of the fuel cell stack 70 and appears at an anode exhaust outlet 76 of the stack 70. In this context of this application, the “anode chamber” refers to the anode inlet and outlet plenum passageways as well as the anode flow plate channels of the fuel cell stack 70.

As depicted in FIG. 4, in accordance with some embodiments of the invention, the fuel cell system 50 includes an electrochemical cell separator, or hydrogen pump 160, which produces a relatively pure hydrogen flow (at its outlet 164) that flows back to the anode inlet 72. The hydrogen pump 160 may also include an exhaust outlet 168 for purposes of communicating a nitrogen bleed flow.

In accordance with some embodiments of the invention, the fuel cell system 50 includes a control subsystem for purposes of controlling the above-described flows for purposes of increasing the partial pressure of oxygen in the air reactant stream and desorbing nitrogen from the PPSA beds 100 and 150. More specifically, in accordance with some embodiments of the invention, the control subsystem includes a controller 80 (one or more microcontrollers or microprocessors, for example) and valves that are controlled by the controller 80 for purposes of routing the adsorption and desorption flows through the fuel cell system 50. The controller 80 includes input terminals 82 for purposes of receiving status signals, communications from other entities, measured currents and voltages, etc., depending on the particular embodiment of the invention. In response to these received inputs as well as the execution of software or firmware program code, the controller 80 generates signals on output terminals 84 of the controller 80 to control the various components of the fuel cell system 50. In this manner, the controller 80 may execute program instructions for purposes of operating various valves (described below) of the fuel cell system 50 to control the adsorption and desorption flows that are described herein.

For purposes of controlling the flows through the PPSA beds 100 and 150, the fuel cell system 50 include valves 102 and 106 that control communication between the inlet 90 and the outlet 107 to regulate when the PPSA bed 100 is adsorbing nitrogen from the air reactant stream; and valves 129 and 130 that control when the PPSA bed 100 is releasing its captured nitrogen to a hydrogen flow. The valves 102, 106, 129 and 130 may be controlled by the controller 80. More specifically, when the PPSA bed 100 is in its adsorption state, the valves 102 and 106 are open; and the valves 129 and 130 are closed. In this configuration, the air reactant stream enters the inlet 90, flows through the open valve 102, through the PPSA bed 100, through the valve 106 and then to the cathode inlet 74 of the fuel cell stack 70. Due to their closed states, the valves 129 and 130 block the flow of hydrogen through the PPSA bed 100 and thus, isolate the hydrogen source 120 from the bed 100.

In the desorption state of the PPSA bed 100, the valves 102 and 106 are closed while the valves 129 and 130 are open. In this configuration, hydrogen flows from the pure hydrogen source 120 through the inlet 122, through the open valve 129 and into the PPSA bed 100. While flowing through the PPSA bed 100, the hydrogen desorbs trapped nitrogen from the bed 100 and emerges from the bed 100 to flow through the open valve 130. From the valve 130, the combined hydrogen and nitrogen stream exits the outlet 91 and is communicated to the anode inlet 72 of the fuel cell stack 70.

Similar valves 112, 124, 140 and 142 control the flows through the PPSA bed 150 and may also be controlled by the controller 80. In this regard, the valves 112 and 124 are open (and valves 140 and 142 are closed) to cause hydrogen to flow from the pure hydrogen source 120 through the PPSA bed 150 during the regeneration of the bed 150. Valves 140 and 142 are open (and valves 112 and 124 are closed) during the adsorption state of the PPSA bed 150 to flow the air reactant stream through the bed 150.

The oxygen enriching PPSA bed may be also used in a natural gas-based fuel cell system that contains a reformer to provide a reformate flow (a flow of approximately 50% hydrogen, for example) to the fuel cell stack. In this regard, the fuel cell system may receives a natural gas flow and converts the flow into the reactant reformate flow that is provided to the anode chamber of the stack.

For the natural gas-based fuel cell system, the natural gas stream may be used as a desorbing stream. However, using the natural gas stream as the desorption stream is difficult primarily due to the mole flow rate of natural gas in that the mole flow rate is only about 60% of the processed oxygen's mole flow rate. Another potential challenge in using the natural gas stream as the desorbing stream is the relatively high nitrogen content that would end up in the natural gas feed to the reformer.

A second potential desorbing gas stream in the natural gas-based fuel cell system is the anode exhaust from the fuel cell stack. The overall approach is to use a partial oxidation reformer (for example) and process sufficient oxygen to both react within the stack and react in the partial oxidation reformer, in accordance with some embodiments of the invention. In this way, the anode exhaust is essentially nitrogen free; and hydrogen, carbon dioxide and argon are the non-condensable gases.

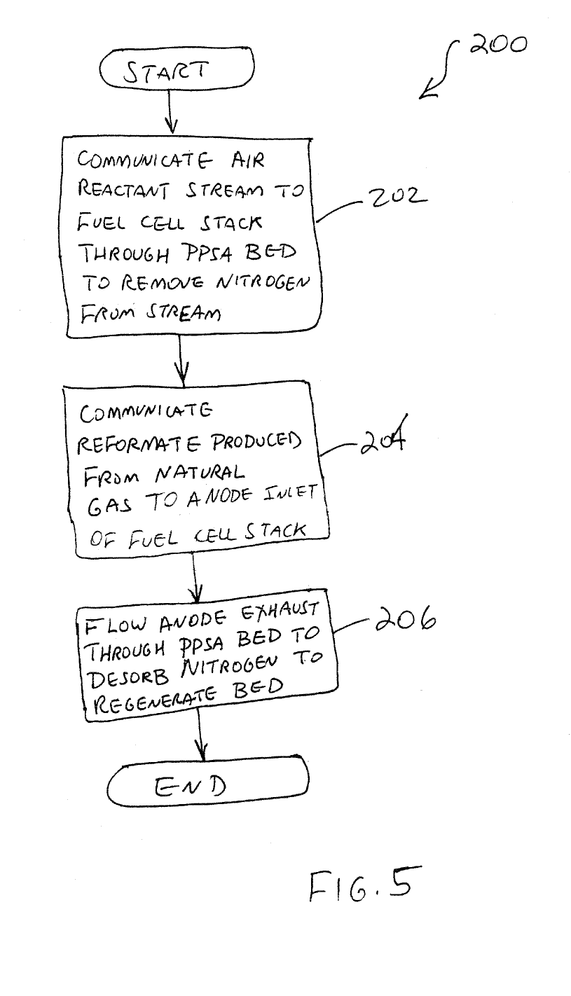

Referring to FIG. 5, thus, a technique 200 in accordance with some embodiments of the invention includes communicating an air reactant stream to a fuel cell stack through a PPSA bed to remove nitrogen from the stream, as depicted in block 202. Reformate that is produced from natural gas is communicated (block 204) to the anode inlet of the fuel cell stack. The anode exhaust is flowed through the PPSA bed (block 206) to desorb nitrogen to regenerate the bed.

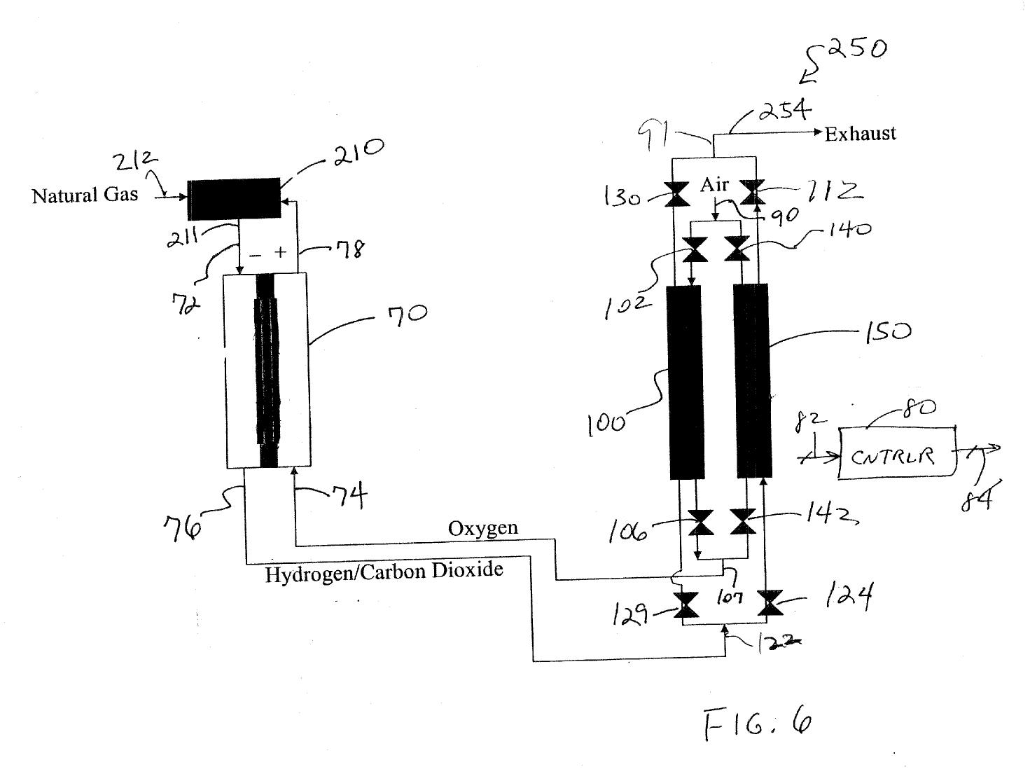

As a more specific example, FIG. 6 depicts an exemplary embodiment of a natural gas-based fuel cell system 250 in accordance with some embodiments of the invention. The fuel cell system 250 has a similar design to the fuel cell system 50 (see FIG. 4) with like reference numerals being used for similar components. However, the fuel cell system 250 has the following differences. In particular, the fuel cell system 250 includes a reformer 210 (a partial oxidation reformer, for example) that receives natural gas (at its inlet 212) to produce a reformate flow at its outlet 211. Thus, the reformer 210 replaces the pure hydrogen source 120 of the fuel cell system 50. The reformate flow is routed to the anode inlet 72 of the fuel cell stack 70, as depicted in FIG. 6.

As shown in FIG. 6, the anode exhaust of the fuel cell stack 70 is used to desorb nitrogen from the adsorbent beds 100 and 150. Thus, the inlet 122 is connected to the anode exhaust outlet 76 of the fuel cell stack 70 instead of to a relatively pure hydrogen source. Among the other differences, the fuel cell system 250 does not route the desorbed gas flow from the bed 100, 150 back to the fuel cell stack 70. Instead, as depicted in FIG. 6, the outlet 91 is coupled to an exhaust conduit 254. As an example, the exhaust may be routed to an oxidizer, in accordance with some embodiments of the invention.

Without passing the reformate through the bed 100, 150 for purposes of desorption, a 1.2 hydrogen stoichiometry may be used (see Equations 1 and 2). However, the 1.2 hydrogen stoichiometry does not provide a sufficient mole flow rate of non-condensable anode exhaust gases to desorb the nitrogen when the reformate is flowed through the bed 150, 152. Therefore, in accordance with some embodiments of the invention, the hydrogen stoichiometry is increased to provide the sufficient mole flow rate. For example, in accordance with some embodiments of the invention, the hydrogen stoichiometry may be increased from 1.2 to 1.25. Although this increase by itself may degrade the system efficiency, the overall system efficiency is increased by the fuel cell oxygen partial pressure increase.

Many variations are possible and are within the scope of the appended claims. For example, in accordance with some embodiments of the invention, the fuel cell system may reform another hydrocarbon other than natural gas, such as liquefied petroleum gas (LPG), for example. As another example, the fuel cell system 250 may include a condenser for purposes of condensing out water/water vapor from the anode exhaust before the anode exhaust passes through the adsorbent bed 100, 150. Some adsorbents may tolerate water vapor whereas others cannot. Therefore, if the selected adsorbent cannot tolerate water vapor, a condenser may be added, such as a regenerative thermal swing dryer, for example.

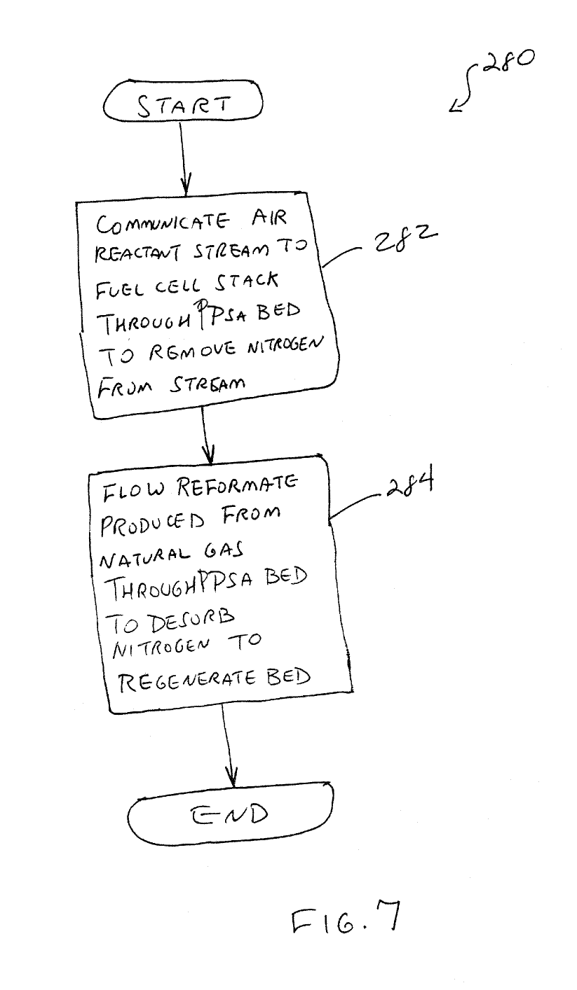

In other embodiments of the invention, the reformate flow from the output of the reformer 210 may be used to desorb nitrogen from the regenerating bed 100, 150. In this regard, FIG. 7 depicts a technique 280 in accordance with some embodiments of the invention. Pursuant to the technique 280, an air reactant stream to the fuel cell stack is communicated (block 282) through a PPSA bed to remove nitrogen from the stream. Reformate that is produced from natural gas is flowed (block 284) through the PPSA bed to desorb nitrogen to regenerate the bed.

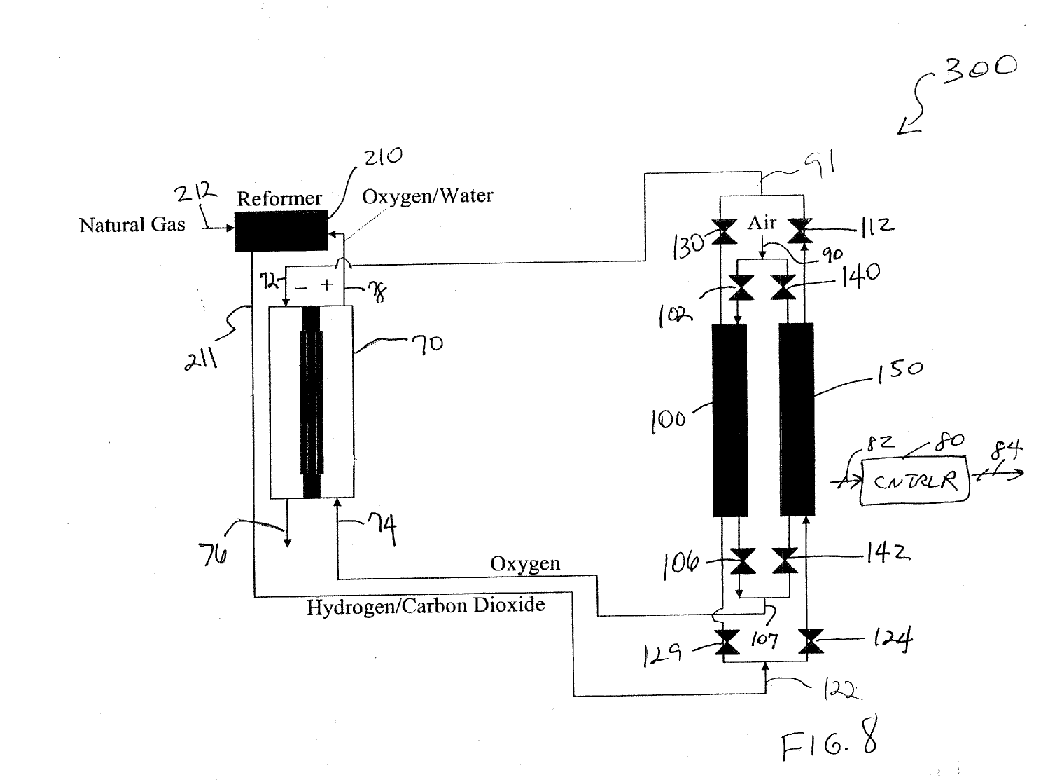

FIG. 8 depicts an exemplary embodiment 300 for a natural gas-based fuel cell system in accordance with some embodiments of the invention. The fuel cell system 300 is similar in design to the fuel cell system 250 (see FIG. 6), with like reference numerals being used to depict similar components. However, the fuel cell system 300 has the following differences. In particular, the desorption gas inlet 122 of the fuel cell system 300 is connected to the reformate outlet 211 of the reformer 210 instead of to the anode exhaust outlet 76 of the fuel cell stack 70. Thus, reformate flows through one of the beds 100 and 150 for purposes of regenerating the bed 150. As also depicted in FIG. 8, the desorption gas outlet 91 is connected to the anode inlet 72 of the fuel cell stack 70, instead of being connected to an exhaust line. Thus, when a particular bed 100, 150 is being regenerated, the reformate flows from the reformer 210, through the bed 100, 150 being regenerated, into the anode chamber of the fuel cell stack 70 and then exits the fuel cell stack 70 at its anode exhaust 76. The anode exhaust may be routed back to the anode inlet 72, may be sent to an oxidizer, etc., depending on the particular embodiment of the invention.

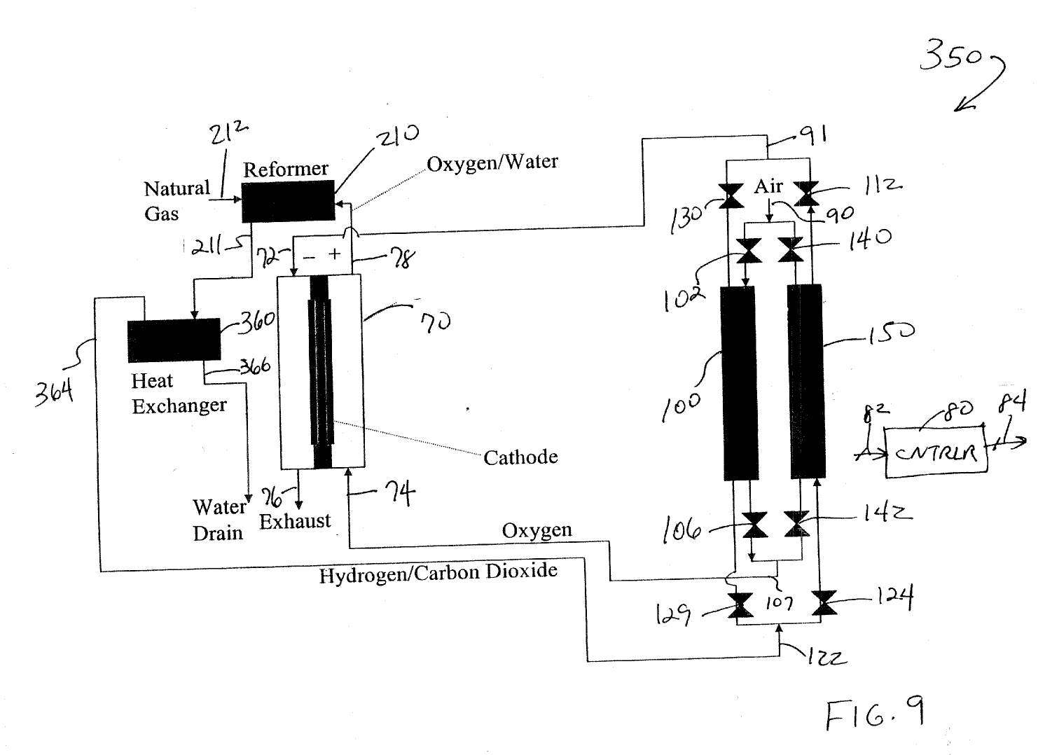

In some embodiments of the invention, the PPSA bed may not tolerate the moisture content of the reformate flow. For these adsorbents, a natural gas-based fuel cell system 350 that is depicted in FIG. 9 may be used. The fuel cell system 350 has a similar design to the fuel cell system 300 (see FIG. 8) with like reference numerals being used to designate similar components. However, the fuel cell system 350 has the following differences. In particular, the fuel cell system 350 includes a heat exchanger 360 that reduces the temperature of the reformate flow. In this regard, the reformate outlet 211 of the reformer 210 is coupled to the heat exchanger 360 so that the reformate flows through the heat exchanger 360 to exit the heat exchanger 360 (at its outlet 364) at a reduced temperature. In accordance with some embodiments of the invention, the heat exchanger 360 may be an air heat exchanger that reduces the dew point to about 30° C. At 30° C., some PPSA adsorbents tolerate the moisture content without significant adsorption of the water vapor.

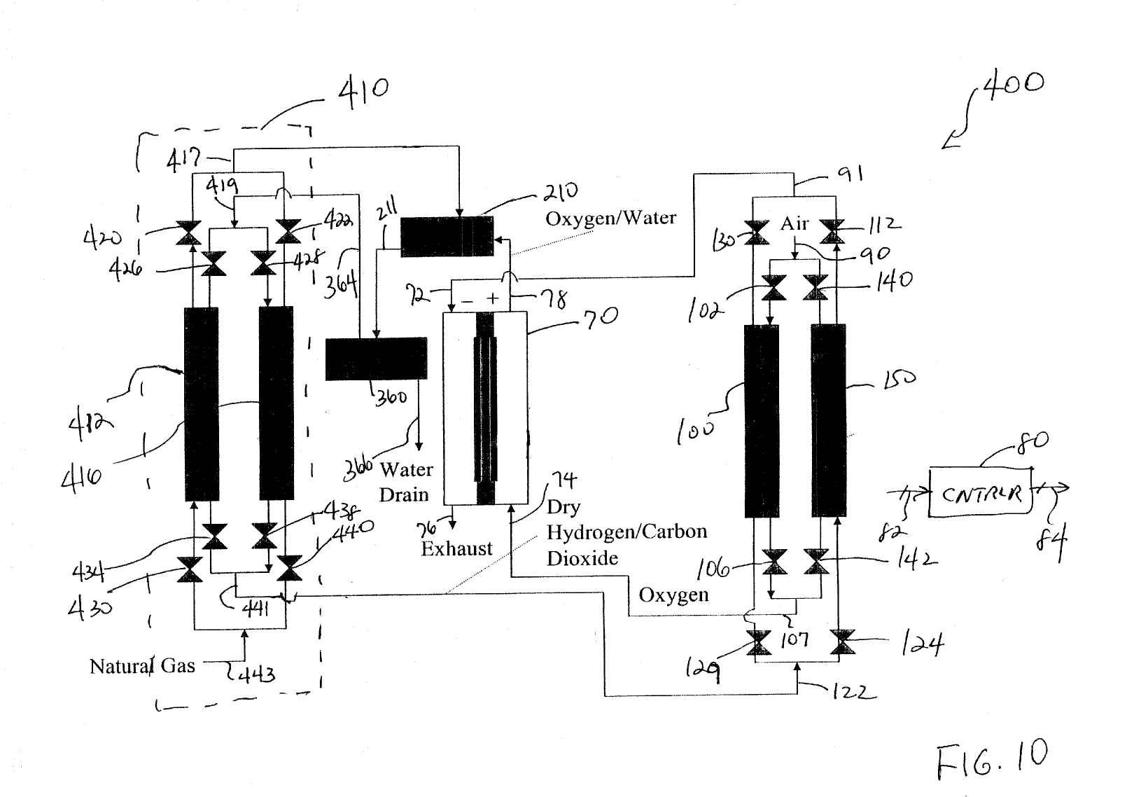

In the event that the selected adsorbent is not tolerated at the dew point that is achieved by the heat exchanger, the exhaust from the reformer 210 may be further dried by a PPSA adsorbent bed. More specifically, FIG. 10 depicts a natural gas-based fuel cell system 400 in accordance with some embodiments of the invention. The fuel cell system 400 has a similar design to the fuel cell system 350 (see FIG. 9) with like reference numerals being used to depict similar components, with the following differences. In particular, the fuel cell system 400 includes an adsorption bed subsystem 410 that receives the flow from the heat exchanger 360, further dries out this flow and provides the relatively dry adsorbent flow to the adsorbent flow inlet 122. The adsorbent subsystem 410 includes adsorbent beds 412 and 416 that adsorb water vapor from the reformate flow while rejecting methane, hydrogen, carbon dioxide and carbon monoxide, in accordance with some embodiments of the invention. The beds 412 and 416 are regenerated using the incoming natural gas flow. The adsorbent beds 412 and 416 alternate adsorption and desorption states, similar to the alternation of states of the adsorbent beds 100 and 150. Thus, at any particular time, one of the adsorption beds 412 and 416 is adsorbing water from the reformate flow, and the other of the adsorbent beds 412 and 416 is being regenerated by the incoming natural gas flow.

Thus, to summarize, the relatively wet reformate from the heat exchanger 360 flows into the subsystem 410 where water is further removed from the reformate. The dried reformate flows from the subsystem 410, through the regenerating adsorbent bed 100, 150 and then flows into the anode chamber of the fuel cell stack 70. For purposes of regenerating a particular adsorbent bed 412, 416, the incoming natural gas flow is used. In this manner, the natural gas flow flows through the regenerating adsorbent bed 412, 416 and then into the inlet of the reformer 210.

Similar to the arrangement used in connection with the adsorbent beds 100 and 150, the subsystem 410 includes various valves to control the flows through the adsorbent beds 412 and 416. More specifically, valves 426, 428, 434 and 438 control the communication of the reformate flow for purposes of selecting which adsorbent bed 412 and 416 is removing water from the reformate. The valves 426 (connected to a reformate inlet 419 of the subsystem 410) and 434 (connected to a reformate outlet 441 of the subsystem 410) are open and the valves 428 (connected to the inlet 419) and 438 (connected to the outlet 441) are closed for purposes of selecting the adsorbent bed 412 to remove water from the incoming reformate flow. Conversely, the valves 428 and 438 are open and the valves 426 and 434 are closed for purposes of selecting the adsorbent bed 416 to remove water from the incoming reformate flow.

To select the particular adsorbent bed 412, 416 that is being regenerated, the subsystem 410 includes valves 420, 422, 430 and 440. When the adsorbent bed 412 is being regenerated by the incoming natural gas flow, the valves 420 (connected to a natural gas outlet 417 of the subsystem 410) and 430 (connected to a natural gas inlet 443 of the subsystem 410) are open and the valves 422 (connected to the outlet 417) and 440 (connected to the inlet 443) are closed. When the adsorbent bed 416 is being regenerated by the incoming natural gas flow, the valves 422 and 440 are open, and the valves 420 and 430 are closed.

While the invention has been disclosed with respect to a limited number of embodiments, those skilled in the art, having the benefit of this disclosure, will appreciate numerous modifications and variations therefrom. It is intended that the appended claims cover all such modifications and variations as fall within the true spirit and scope of the invention.

What is claimed is:

1. A method comprising:
removing nitrogen from an air stream to produce an enriched oxygen stream;
communicating the enriched oxygen stream to a cathode chamber of a fuel cell; and
transferring the nitrogen removed from the air stream to a reactant stream of the fuel cell.

2. The method of claim 1, wherein transferring comprises transferring the nitrogen to a fuel stream that is received by the fuel cell.

3. The method of claim 2, wherein the fuel stream comprises hydrogen.

4. The method of claim 1, wherein transferring comprises transferring the nitrogen directly to an exhaust stream of the fuel cell.

5. The method of claim 1, wherein transferring comprises transferring the nitrogen to a reformate stream.

6. The method of claim 5, further comprising:
communicating the reformate stream to the fuel cell.

7. The method of claim 5, further comprising removing water from the reformate stream before transferring the nitrogen to the reformate stream.

8. The method of claim 7, wherein the removing the water comprises:
routing the reformate flow through at least one of a heat exchanger and a partial pressure adsorption bed.

9. A method comprising:
communicating an air stream through a partial pressure adsorption bed to produce an enriched oxygen stream;
communicating the enriched oxygen stream to a cathode chamber of a fuel cell; and
communicating a reactant stream of the fuel cell other than the air stream through the adsorption bed to regenerate the bed.

10. The method of claim 9, wherein the act of communicating said another stream through the adsorption bed comprises desorbing nitrogen from the bed.

11. The method of claim 9, wherein the act of communicating said another stream comprises communicating a fuel stream that is to be received by the fuel cell through the adsorption bed.

12. The method of claim 11, wherein the fuel stream comprises hydrogen.

13. The method of claim 9, wherein the act of communicating said another stream comprises communicating an exhaust stream from the fuel cell through the adsorption bed.

14. The method of claim 9, wherein the act of communicating said another stream comprises communicating a reformate stream through the adsorption bed.

15. The method of claim 9, further comprising:
using an additional partial pressure adsorption bed to produce the oxygen enriched stream during the act of communicating said another stream.

16. The method of claim 15, further comprising:
communicating said another stream through the additional partial pressure adsorption bed to regenerate the bed during the act of communicating the air stream through the first partial pressure adsorption bed.

17. A fuel cell system comprising:
a fuel cell comprising a cathode chamber;
a partial pressure adsorption bed; and
a control subsystem adapted to:
communicate an air stream through the partial pressure adsorption bed to produce an enriched oxygen stream,
communicate the enriched oxygen stream to the cathode chamber and
communicate a reactant stream of the fuel cell system other than the air stream through the adsorption bed to regenerate the bed.

18. The fuel cell system of claim 17, wherein said another stream comprises a fuel stream that is to be received by the fuel cell after being communicated through the adsorption bed.

19. The fuel cell system of claim 18, wherein the fuel stream comprises hydrogen.

20. The fuel cell system of claim 17, wherein said another stream comprises an exhaust stream from the fuel cell.

21. The fuel cell system of claim 17, wherein said another stream comprises a reformate stream.

22. The fuel cell system of claim 21, further comprising:
a heat exchanger to remove water from the reformate stream.

23. The fuel cell system of claim 21, further comprising:
another adsorption bed adapted to remove water from the reformate stream.

24. The fuel cell system of claim 23, wherein the control subsystem is adapted to flow natural gas through said another adsorption bed to regenerate the bed.

25. The fuel cell system of claim 17, wherein the adsorption bed one of a plurality of adsorption beds that alternate between being regenerated and enriching the air stream with oxygen.
